(19) United States
(12) Patent Application Publication
(10) Pub. No.: US 2012/0088074 A1
(43) Pub. Date: Apr. 12, 2012

(54) WORKPIECE WITH THREE-DIMENSIONAL PATTERN

(75) Inventors: Wan-Li Chuang, Taipei City (TW); Chien-Min Chang, Taipei City (TW); Li-Jung Yu, Taipei City (TW); Yung-Ching Chang, Taipei City (TW); Ying-Ching Chen, Taipei City (TW); Tsung-Sheng Chuang, Taipei City (TW)

(73) Assignee: COMPAL ELECTRONICS, INC., Taipei City (TW)

(21) Appl. No.: 13/329,340

(22) Filed: Dec. 19, 2011

Related U.S. Application Data
(63) Continuation-in-part of application No. 12/881,185, filed on Sep. 14, 2010.
(60) Provisional application No. 61/241,962, filed on Sep. 14, 2009.

(51) Int. Cl. B32B 3/26

(52) U.S. Cl. 428/172

(57) ABSTRACT

A workpiece with three-dimensional pattern having a three-dimensional surface and suitable for an electronic device is provided. A multiple three-dimensional micro patterns formed on the three-dimensional surface reflects an environment light to form images with a visual effect. The workpiece with three-dimensional pattern includes a workpiece and an adhesive layer. The adhesive layer is disposed on the workpiece and impressed to form the multiple three-dimensional micro patterns, and the workpiece is punched to form the three-dimensional surface. A first part of the multiple three-dimensional micro patterns on the three-dimensional surface reflects the environment light to form a first reflecting light beam. A second part of the multiple three-dimensional micro patterns on the three-dimensional surface reflects the environment light to form a second reflecting light beam. The images with visual effect includes at least the first reflecting light beam, the second reflecting light beam, and the multiple three-dimensional micro patterns.

### CROSS-REFERENCE TO RELATED APPLICATION

This application is a continuation-in-part application of and claims the priority benefit of a U.S. prior application Ser. No. 12/881,185, filed on Sep. 14, 2010, now pending. The prior application Ser. No. 12/881,185 claims the priority benefit of U.S. provisional application Ser. No. 61/241,962, filed on Sep. 14, 2009. The entirety of each of the above-mentioned patent applications is hereby incorporated by reference herein and made a part of this specification.

### BACKGROUND OF THE INVENTION

1. Field of the Invention

The invention generally relates to a workpiece, and more particularly to a workpiece with three-dimensional pattern.

2. Description of Related Art

Currently, electronic devices such as notebook computers, mobile phones, or digital cameras mostly adopt metal material for constituting the exterior. In order to advance the overall aesthetic appearance of electronic devices, various patterns are usually formed on the appealing configuration. Patterns are produced on the surface of metal material frequently by etching metal material with a solvent or by paint-spraying and transfer printing. Nonetheless, the surface treatment technique of the former is complicated and difficult, and the latter is restrained by the chemical property of metal material, such that artistic configuration cannot be produced.

### SUMMARY OF THE INVENTION

The invention is directed to a workpiece, wherein an adhesive layer having multiple three-dimensional micro patterns is disposed on the workpiece to form three-dimensional visual effect.

An embodiment of the invention provides a workpiece with three-dimensional pattern having a three-dimensional surface and suitable for an electronic device. A multiple three-dimensional micro patterns formed on the three-dimensional surface reflects an environment light to form images with a visual effect. The workpiece with three-dimensional pattern includes a workpiece and an adhesive layer. The adhesive layer is disposed on the workpiece and impressed to form the multiple three-dimensional micro patterns, and the workpiece is punched to form the three-dimensional surface. A first part of the multiple three-dimensional micro patterns on the three-dimensional surface reflects the environment light to form a first reflecting light beam. A second part of the multiple three-dimensional micro patterns on the three-dimensional surface reflects the environment light to form a second reflecting light beam. The images with visual effect includes at least the first reflecting light beam, the second reflecting light beam, and the multiple three-dimensional micro patterns.

In light of the foregoing, in the embodiments of the invention, the adhesive layer is disposed on the workpiece, such that one part of the multiple three-dimensional micro patterns on the three-dimensional surface reflects the environment light to form a first reflecting light beam while another part of the multiple three-dimensional micro patterns on the three-dimensional surface reflects the environment light to form a second reflecting light beam. Through the multiple three-dimensional micro patterns of the adhesive layer, the first reflecting light beam and the second reflecting light beam may have different phases to be counteracted each other or have the same phases to be added together, such that three-dimensional visual effect is formed to advance the aesthetic appearance of the workpiece.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a workpiece with three-dimensional pattern according to an embodiment of the invention.

FIG. 2 is a partial schematic view of a workpiece with three-dimensional pattern according to another embodiment of the invention.

FIG. 3A to FIG. 3C showing a manufacturing process of the workpiece with three-dimensional pattern in FIG. 1.

FIG. 4 is a partial schematic view of a workpiece with three-dimensional pattern according to another embodiment of the invention.

FIG. 5 is a partial schematic view of a workpiece with three-dimensional pattern according to another embodiment of the invention.

### DESCRIPTION OF EMBODIMENTS

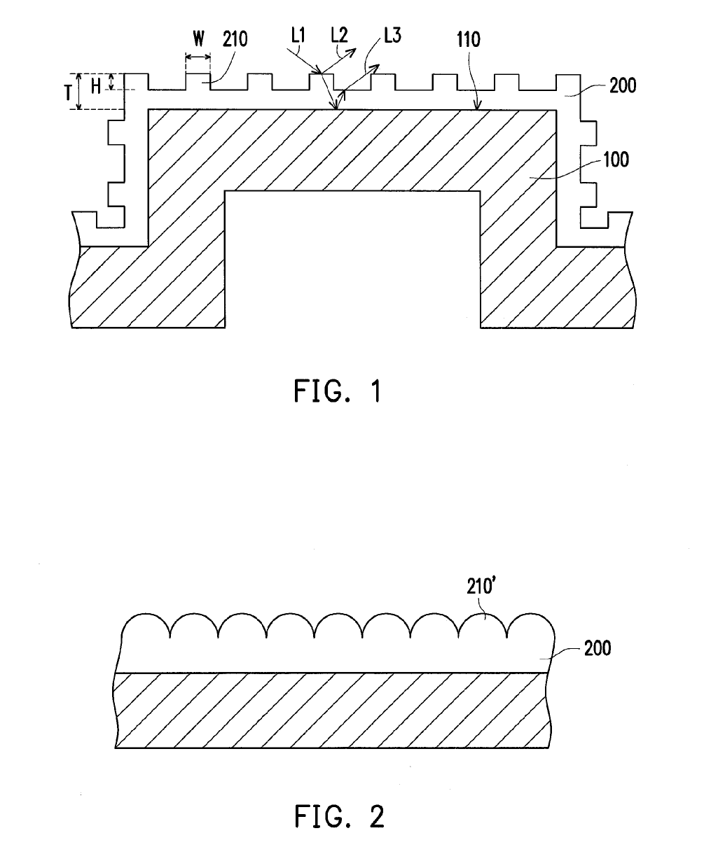

FIG. 1 is a schematic view of a workpiece with three-dimensional pattern according to an embodiment of the invention. Referring to FIG. 1, a workpiece with three-dimensional pattern includes a workpiece 100 and an adhesive layer 200. The adhesive layer 200 is disposed on the workpiece 100 and is impressed to form a multiple three-dimensional micro patterns. The workpiece 100 is punched to form a three-dimensional surface 110. A first part of the multiple three-dimensional micro patterns on the three-dimensional surface 110 reflects the environment light L1 to form a first reflecting light beam L2, and a second part of the multiple three-dimensional micro patterns on the three-dimensional surface 110 reflects the environment light L1 to form a second reflecting light beam L3, such that images with a visual effect is formed. The images with the visual effect includes at least the first reflecting light beam L2, the second reflecting light beam L3, and the multiple three-dimensional micro patterns of the adhesive layer 200. The workpiece with three-dimensional pattern shown in FIG. 1 is, for example, a part of an electronic device.

In the disposing manner above-mentioned, the adhesive layer 200 is disposed on the workpiece 100, such that one part of the multiple three-dimensional micro patterns on the three-dimensional surface 110 reflects the environment light L1 to form the first reflecting light beam L2 while another part of the multiple three-dimensional micro patterns on the three-dimensional surface 110 reflects the environment light L1 to form a second reflecting light beam L3. Through the multiple three-dimensional micro patterns of the adhesive layer 200, the first reflecting light beam L2 and the second reflecting light beam L3 may have different phases to be counteracted each other or have the same phases to be added together, such that three-dimensional visual effect is formed to advance the aesthetic appearance of the workpiece 100.

For example, the first reflecting light beam L2 is reflected by the adhesive layer 200, and the second reflecting light beam L3 is reflected by the workpiece 100 and refracted by the adhesive layer 200, such that the first reflecting light beam L2 and the second reflecting light beam L3 have different phases to be counteracted each other or have the same phases to be added together.

When a plurality of light beams L1 are respectively reaches different regions of the adhesive layer 200, the multiple three-dimensional micro patterns of the adhesive layer 200 causes different reflecting effects and different refracting effects in different regions of the adhesive layer 200, such that phase variation of one reflecting light beam could be different from phase variation of another reflecting light beam. Thus, counteracting effects of reflecting light beams and adding effects of light beams are different in different regions so that the three-dimensional visual effect above-mentioned is formed.

In the present embodiment, the workpiece 100 is made of, for example, aluminum alloy (5052), stainless steel (430, 304), cold rolling steel (spcc), magnesium alloy (AZ91D, AZ61) or other metal materials suitable for constituting the exterior.

Particularly, the adhesive layer 200 has a plurality of optical micro structures 210 to form the multiple three-dimensional micro patterns. Each of the optical micro structures 210 has a cross-section of rectangle. Each of the optical micro structures 210 has a width W of 20 μm to 500 μm (perfectly 50 μm to 1500 μm) and a height H of 1 μm to 20 μm. (perfectly 5 μm to 12 μm) The adhesive layer 200 has a thickness T of 5 μm to 50 μm (perfectly 10 μm to 20 μm) and a transparency of 5 percent to 100 percent. In other embodiments, each of the optical micro structures 210 can have any other suitable width and any other suitable height, the adhesive layer 200 can have any other suitable thickness and any other suitable transparency, and the present invention is not limited thereto.

FIG. 2 is a partial schematic view of a workpiece with three-dimensional pattern according to another embodiment of the invention. Referring to FIG. 2, each of the optical micro structures 210′ of the adhesive 200 has a cross-section of semicircle. In other embodiments, each of the optical micro structures can have a cross-section of any other suitable shapes, and the present invention is not limited thereto.

In the present embodiment, the workpiece 100 is, for instance, a metal plate, a fiber and metal plate or a carbon-fiber and metal plate. Thus, in the process of producing this workpiece 100, the production efficiency of the workpiece 100 can enhanced by transporting and processing with a roller apparatus.

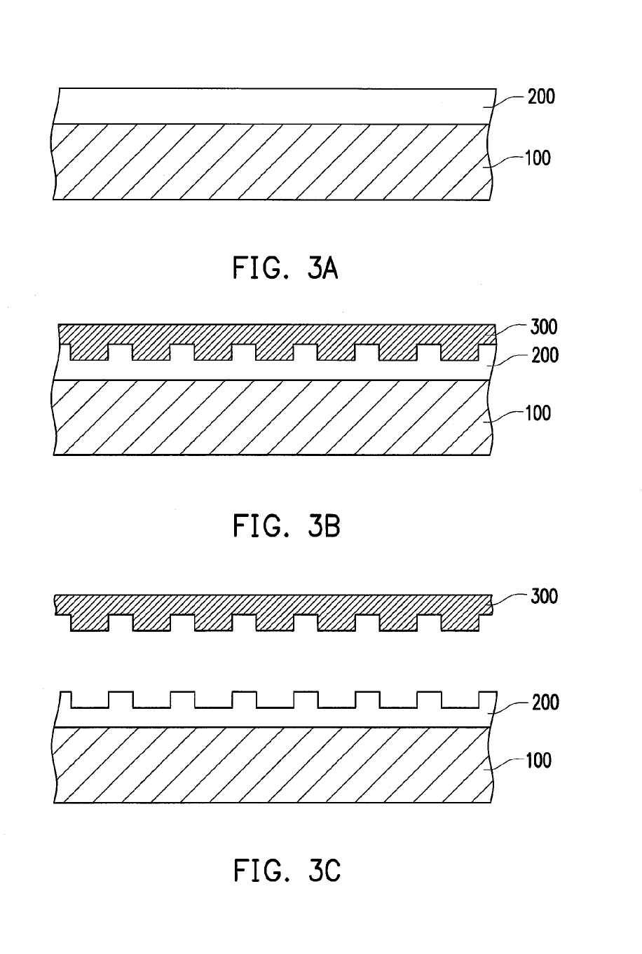

FIG. 3A to FIG. 3C showing a manufacturing process of the workpiece with three-dimensional pattern in FIG. 1. The adhesive layer 200 is disposed on the workpiece 100 as shown in FIG. 3A, and the adhesive layer 200 disposed on the workpiece 100 is impressed by a mold 300 as shown in FIG. 3B, such that the multiple three-dimensional micro patterns shown in FIG. 3C is formed. Then, the workpiece 100 is punched to form the three-dimensional surface 110 shown in FIG. 1.

In this embodiment, the workpiece 100 could be processed using a punching apparatus so as to punch the workpiece 100 from a plate state into a three-dimensional workpiece. Accordingly, the workpiece 100 of the present embodiment first forms the multiple three-dimensional micro patterns by disposing the adhesive layer 200 on the workpiece 100, and the workpiece 100 is then processed by the punching apparatus depending on the configuration required. Consequently, the technical difficulty of forming the multiple three-dimensional micro patterns on the surface of the three-dimensional workpiece is overcome, and the suitability of the workpiece 100 is further increased.

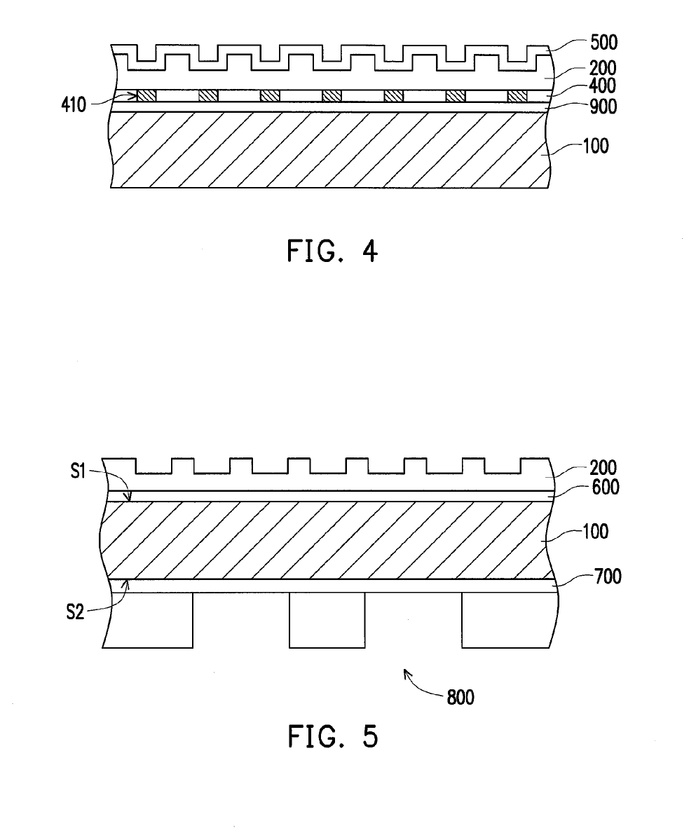

FIG. 4 is a partial schematic view of a workpiece with three-dimensional pattern according to another embodiment of the invention. Unlike the above embodiment, before the adhesive layer 200 is applied on the workpiece 100, a primer layer 900 is first applied on the workpiece 100 for adhering the adhesive layer 200 and the workpiece 100, wherein the primer layer 900 also reflects the above-mentioned environment light to form the visual effect. In addition, in the present embodiment, a color layer 400 is further disposed on the primer layer 300, so as to color the workpiece 100, wherein the color layer 400 also reflects the above-mentioned environment light to form the visual effect. The method of coloring the workpiece 100 is not limited in the present embodiment, and the color layer 400 can be disposed on the primer layer 300 by applying, screen printing, offset printing or intaglio printing. The color layer 400 may has two-dimensional patterns 410, which and the multiple three-dimensional micro patterns are continuous at bending portions of the workpiece 100. The thickness of portions of the adhesive layer 200 at bending portions of the workpiece 100 is less than the thickness of portions of the adhesive layer 200 at flat portions of the workpiece 100. Therefore, the multiple three-dimensional micro patterns of the adhesive layer 200 and the two-dimensional patterns 410 can generate three-dimensional visual effects of pattern or grating by interference. After the adhesive layer 200 is cured, a passivation layer 500 is disposed thereon to prevent the following punching process from damaging the surface of the workpiece 100, wherein the passivation layer 500 also reflects the above-mentioned environment light to form the visual effect.

In other embodiments, more color layers with different colors could be applied between the adhesive layer 200 and the primer layer 300, and the present invention is not limited thereto.

FIG. 5 is a partial schematic view of a workpiece with three-dimensional pattern according to another embodiment of the invention. Referring to FIG. 5, in the present embodiment, the workpiece 100 has a first surface S1 and a second surface S2 disposed in a back to back manner. Before the adhesive layer 200 is applied, a first primer layer 600 and a second primer layer 700 are applied on the first surface S1 and the second surface S2 respectively. Consequently, the first surface S1 and the second surface S2 of the workpiece 100 are adhesive. Thereafter, the adhesive layer 200 is applied on the first primer layer 600. After the adhesive layer 200 is cured, a plurality of three-dimensional components 800 are formed on the second primer layer 700 on the second surface S2 of the workpiece 100 by using the injection molding technique. These three-dimensional components 800 are, for example, a plurality of bosses for assembling other components on the workpiece 100 conveniently.

On the other hand, referring to FIGS. 4 and 5 simultaneously, in the embodiment shown in FIG. 5, the first primer layer 600 is a color primer layer, where a color dye is added to the primer layer 600, for example. Thus, the workpiece 100 is colored without having additional color layer 400 printed on the primer layer 300 in FIG. 4.

In summary, in the aforementioned embodiments of the invention, the adhesive layer is disposed on the workpiece, such that one part of the multiple three-dimensional micro patterns on the three-dimensional surface reflects the environment light to form a first reflecting light beam while another part of the multiple three-dimensional micro patterns on the three-dimensional surface reflects the environment light to form a second reflecting light beam. Through the multiple three-dimensional micro patterns of the adhesive layer, the first reflecting light beam and the second reflecting light beam may have different phases to be counteracted each other or have the same phases to be added together, such that three-dimensional visual effect is formed to advance the aesthetic appearance of the workpiece.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A workpiece with three-dimensional pattern, having a three-dimensional surface and suitable for an electronic device, wherein a multiple three-dimensional micro patterns is formed on the three-dimensional surface and reflects an environment light to form images with a visual effect, and the workpiece with three-dimensional pattern comprising:
a workpiece; and
an adhesive layer disposed on the workpiece, wherein the adhesive layer is impressed to form the multiple three-dimensional micro patterns, and the workpiece is punched to form the three-dimensional surface,
wherein a first part of the multiple three-dimensional micro patterns on the three-dimensional surface reflects the environment light to form a first reflecting light beam, and a second part of the multiple three-dimensional micro patterns on the three-dimensional surface reflects the environment light to form a second reflecting light beam,
wherein the images with the visual effect are comprised of at least the first reflecting light beam, the second reflecting light beam, and the multiple three-dimensional micro patterns.

2. The workpiece with three-dimensional pattern as claimed in claim 1, wherein phase of the first reflecting light beam and phase of the second reflecting light beam are different.

3. The workpiece with three-dimensional pattern as claimed in claim 1, wherein phase of the first reflecting light beam and phase of the second reflecting light beam are the same.

4. The workpiece with three-dimensional pattern as claimed in claim 1, wherein the adhesive layer has a thickness of 5 μm to 50 μm, perfectly 10 μm to 20 μm.

5. The workpiece with three-dimensional pattern as claimed in claim 1, wherein the adhesive layer has a transparency of 5 percent to 100 percent.

6. The workpiece with three-dimensional pattern as claimed in claim 1, wherein the adhesive layer has a plurality of optical micro structures to form the multiple three-dimensional micro patterns.

7. The workpiece with three-dimensional pattern as claimed in claim 6, wherein each of the optical micro structures has a width of 20 μm to 500 μm, perfectly 50 μm to 150 μm.

8. The workpiece with three-dimensional pattern as claimed in claim 6, wherein each of the optical micro structures has a height of 1 μm to 20 μm, perfectly 5 μm to 12 μm.

9. The workpiece with three-dimensional pattern as claimed in claim 6, wherein each of the optical micro structures has a cross-section of semicircle or rectangle.

10. The workpiece with three-dimensional pattern as claimed in claim 1, further comprising:
a primer layer disposed between the workpiece and the adhesive layer, wherein the primer layer reflects the environment light to form the visual effect.

11. The workpiece with three-dimensional pattern as claimed in claim 10, further comprising:
a color layer disposed between the primer layer and the adhesive layer, wherein the color layer reflects the environment light to form the visual effect.

12. The workpiece with three-dimensional pattern as claimed in claim 11, wherein the color layer has a two-dimensional pattern which and the multiple three-dimensional micro patterns forms three-dimensional visual effect.

13. The workpiece with three-dimensional pattern as claimed in claim 10, wherein the primer layer is a color primer layer.

14. The workpiece with three-dimensional pattern as claimed in claim 10, wherein the workpiece has a first surface and a second surface disposed in a back to back manner, the primer layer comprises a first primer layer and a second primer layer, the first primer layer and the second primer layer are applied on the first surface and the second surface respectively, and the adhesive layer is applied on the first primer layer on the first surface.

15. The workpiece with three-dimensional pattern as claimed in claim 14, further comprising:
a three-dimensional component disposed on the second primer layer on the second surface.

16. The workpiece with three-dimensional pattern as claimed in claim 1, further comprising:
a passivation layer disposed on the adhesive layer, wherein the passivation layer reflects the environment light to form the visual effect.

17. The workpiece with three-dimensional pattern as claimed in claim 1, wherein the workpiece is a metal plate, a fiber and metal plate or a carbon-fiber and metal plate.

18. The workpiece with three-dimensional pattern as claimed in claim 1, wherein the workpiece forms a three-dimensional workpiece.
